(19) United States
(12) Patent Application Publication
(10) Pub. No.: US 2013/0211939 A1
(43) Pub. Date: Aug. 15, 2013

(54) Methods, tools & application of encoding & decoding order item permutations using smart handheld devices towards achieving greater order accuracy, efficiency and seamless distributed, non queuing capture process

(71) Applicants: Dimple A. Katira, Raleigh, NC (US); Rajesh K. Hotchandani, Raleigh, NC (US)

(72) Inventors: Dimple A. Katira, Raleigh, NC (US); Rajesh K. Hotchandani, Raleigh, NC (US)

(21) Appl. No.: 13/369,631

(22) Filed: Feb. 9, 2012

(51) Int. Cl. G06Q 30/00

(52) U.S. Cl. 705/26.1

(57) ABSTRACT

Presented here is a summarization of concepts, associated implementation processes, methods and apparatus for generating orders by a customer and logistics involved in the order life cycle as it gets created, transferred and eventually fulfilled by the vendor.

The unique concept requires the order encoding process to be handled on the customer end thereby shifting the order generation responsibility from a vendor to the customer's smart handheld device without intervention and pre-requisites like connectivity and dependence on vendor infrastructure.

The typical associated technology building blocks include a smart handheld device, software components based on a hierarchically structured menu item template, ubiquitous encoding & decoding algorithm, industry standard scanner, integration with vendor infrastructure, and optionally integration with social networking tools.

### BACKGROUND OF THE INVENTION

Traditionally encoding of goods for retail sales has been the responsibility of businesses. Retail outlets, shipping companies, manufacturers all use some form of encoding like bar codes, QR codes etc. to identify specific items. With the rapid penetration of smart handheld devices like smart phones the individual customers carry in their pocket/purse a very powerful device with a computing power very much capable of reversing this tradition of encoding items. This reversal of responsibility has a huge potential in terms of efficiency, accuracy and certainly cost savings for both the customer and the business.

The current order process has a vast room for improvement. An example of such a business is the Fast Food industry. We believe that using a particular industry just as an example helps us articulate the concept better. This does not mean that the application & scope of this concept is just limited to this industry only. The current process requires a customer to stand in line at the counter or drive-thru, convey their order verbally which is error prone, time consuming and frustrating process for the customer thereby compounding the delay for the subsequent customers. This concept eradicates the unpleasant and unintelligible aspects from the current ordering process.

Many businesses have a very structured product item categorization. The clear categorization, presentation and in this case even numbering of product items makes such businesses an ideal use case for taking advantage of this concept and the associated technology offering. For a structured business like the Fast food industry, the order can simply be defined as an enumeration of one of the unique permutation of items offered along with the quantity of each item and possible customer customizations. In this case, the Fast Food vendor would offer a software component that would enable the customer to capture their orders without being physically present at the order fulfillment location using smart handheld device based technology (Android or IPhone device for example). The customer can place an order either at their home, office or even en route to the fast food location without any human to human conversation using a software component on their smart handheld device with no connectivity prerequisites in a self-serve model. As the customer places the order the application guides them through the menus and shows them at each point what they are ordering. This application accommodates any order customization as well. The application provides interactive feedback at each point and finally confirming the order with the customer. Once the order is confirmed, the software component will use an encoding algorithm to generate a code (bar code, QR code or any other industry standard or proprietary encoding that represents their order. This encoding would then become the sole method by which order gets placed by the customer to the business with no verbal intervention or human to human interaction eliminating pitfalls associated with verbal communication like accents thereby guaranteeing a pleasant overall experience.

The key advantage is that the customer is not waiting into a line at the “drive thru” or inside the fast food outlet to verbally convey their order which accelerates the order capture process. The decoding algorithm & tools deployed at the business side would then be responsible for reconstructing the order and subsequently fulfilling it. In this unique order lifecycle model, the order is generated in a distributed fashion, encoded remotely using technology on a customer device, decoded at the business site and fulfilled. The application for the patent covers the concept, the methods, technology and toolset needed that will enable businesses and customers to take advantage of this concept.

### BRIEF DESCRIPTION OF THE DRAWING

The accompanying drawing, which is incorporated in and forms a part of this specification, illustrates embodiments of the invention and, together with the description, serves to explain the principles of the invention.

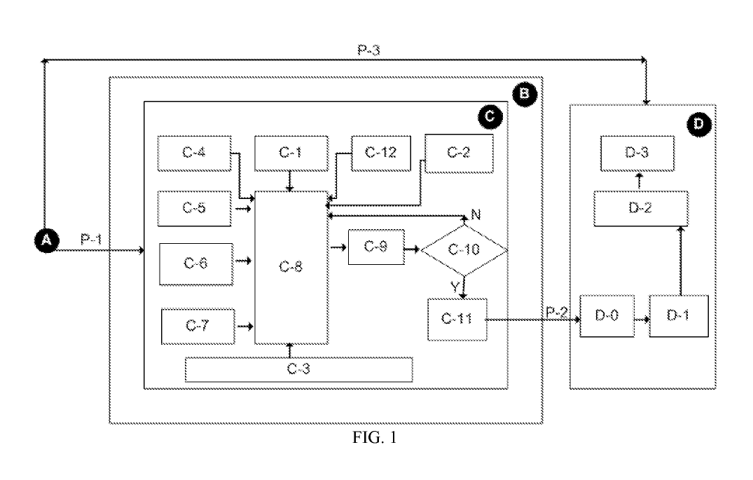

FIG. 1 shows the implementation infrastructure and technology outline of this invention. The items below provide information on what every block in FIG. 1 represents:
A: Customer
B: Handheld Smart Device
C: Order Capture Application
D: Vendor Infrastructure
P-1: Order Creation
P-2: Order Placement
P-3: Order Pick-up
C-1: My Favorites
C-2: External Sharing Interfaces
C-3: Order Metadata storage and Analysis
C-4: Menu Presentation
C-5: Search
C-6: Touch Screen Capture
C-7: Voice Order Capture
C-8: Order Wizard
C-9: Order
C-10: Confirm Order
C-11: Order Encoding Algorithm
C-12: Vendor Branding
D-0: Order Scanner
D-1: Order Decoding Algorithm
D-2: Vendor's Order Capture System
D-3: Order Fulfillment

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

### A. The Customer

“A” in the FIG. 1 represents the Customer or Consumer. One who creates the order using the order capture application (“C” in FIG. 1) deployed on their smart handheld device (“B” in FIG. 1). Later the Customer scans the encoded order generated by the order capture application using a scanner (“D-0” in FIG. 1) at the vendor location. Order creation process (“P-1” in FIG. 1) assumes no connectivity prerequisites. Order placement (“P-2” in FIG. 1) can take the form of either the customer going to the vendor location in the example of a Fast food outlet or restaurant to the walk-in counter or drive thru and scanning their order using a scanner (“D-0” in FIG. 1) at the vendor location with still no connectivity prerequisites or some form of electronic transfer of order in to the vendor infrastructure (“D” in FIG. 1) in which case wireless connectivity will be a prerequisite.

### B. Smart Handheld Device

“B” in the FIG. 1 represents a Smart Handheld device such as a Smart Phone or a tablet PC. This device hosts the software components of the order capture application (“C” in FIG. 1). The order capture application is downloaded and installed on this device. For all practical purposes this is a garden variety Smart phone which is already in use by general public today. Example Android OS based Smart Phone, iPhone etc.

### C. The Order Capture Application

“C” in the FIG. 1 represents the software components of the Order Capture Application. This is the brains of the order capture process. The application will allow a customer (“A” in FIG. 1) to browse menus (“C-4” in FIG. 1), search for products (“C-5” in FIG. 1), display vendor branding (“C-12” in FIG. 1). The application will interact with the customer to create orders (“C-9” in FIG. 1) from vendor product offerings either using voice (“C-7” in FIG. 1), touch screen (“C-6” in FIG. 1) or keyboard interface. The application will encode the orders (“C-11” in FIG. 1) into some form of code i.e. bar code, QR code or any other industry standard or proprietary encoding. This will then become the sole means of information exchange when it comes to order placements (“P-2” in FIG. 1). Other conveniences like book marking favorite orders (“C-1” in FIG. 1) and sharing with family and friends (“C-2” in FIG. 1) will also be provided by the order capture application. For all practical purposes the order capture application can easily become a module into existing vendor applications.

### D. Vendor Infrastructure

“D” in the FIG. 1 represents the Vendor Infrastructure. This is the location at which order placement and fulfillment (“D-3” in FIG. 1) will occur. Customer will simply point the encoded order on their smart handheld device at the scanner (“D-0” in FIG. 1) which would take in the order. The scanner output will get fed into the decoding algorithm (“D-1” in FIG. 1) which will reconstruct this order for display and fulfillment. The external interfaces from the decoding subsystem will create an order for the vendor ordering system (“D-2” in FIG. 1) for fulfillment. A potential enhancement to this system could make the payment process also seamless using integration with services like Google wallet (This is not depicted in the FIG. 1)

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

### REFERENCES CITED

U.S. Patent Documents

| | | |
|---|---|---|
| 6,115,695 | September 2000 | Kern |
| 7,110,964 | September 2006 | Tengler, et al. |

### Other References:

1. Android is a trademark of Google Inc.

2. Google Wallet is a trademark of Google Inc.

3. iPhone is a trademark of Apple Inc.

What is claimed is:

1. A distributed, isolated parallel order capture method with no prerequisites like connectivity, dependence on vendor infrastructure (“D” in FIG. 1) wherein orders are NOT queued or serialized at the time of capture that is based on a interaction between the customer (“A” in FIG. 1) and a smart handheld device (“B” in FIG. 1) allowing the customer to formulate the order at their leisure using voice (“C-7” in FIG. 1), touch screen (“C-6” in FIG. 1) or key methods. The guided capture of order items by a software component (“C” in FIG. 1) that takes in a hierarchically structured customer menu (“C-4” in FIG. 1) translating the menu items for easy access ordering and search (“C-5” in FIG. 1).

2. A method of representing details of the customer order cognizant of all aspects of the order like items, quantities, customization of standard menu items using an encoding algorithm (“C-11” in FIG. 1) resulting in a bar code or QR code and persisting this encoded order on the smart handheld device (“B” in FIG. 1) ready for placement thereby isolating the order capture process from order placement (“P-2” in FIG. 1) and order pick up (“P-3” in FIG. 1).

3. A method of claim 2, that enables further organization of the stored encoded customer orders using the software components (“C” in FIG. 1) on a smart handheld device (“B” in FIG. 1) into user friendly favorites (“C-1” in FIG. 1) thereby facilitating higher efficiency when reordering.

4. A method of claim 2, that enables further tagging of the stored encoded customer orders (“C-1” in FIG. 1) using the software components (“C” in FIG. 1) on a smart handheld device (“B” in FIG. 1) to facilitate sharing of favorite orders among friends and families using tools like Instant messaging, email, text messaging and social networking tools and websites. This is depicted as External Sharing interfaces “C-2” in FIG. 1.

5. A method of claim 2, where the software components (“C” in FIG. 1) on a smart handheld device (“B” in FIG. 1) store metadata about an order item thereby permitting intelligent categorization of individual order items. This is depicted as Order metadata storage and Analysis “C-3” in FIG. 1. This order item metadata for example nutritional information about an order item further playing a key role in enabling sophisticated proximity searching using GPS, product filtering and customer goal fulfillment & tracking using suggestions thereby facilitating integration and data exchange with other applications like Diet & Nutrition planning, Financial tracking & planning application and budgeting tools.

6. A self service order placement process (“P-2” in FIG. 1) by which an accurately captured order using methods of claim 1 and claim 2, is transferred from a smart handheld device (“B” in FIG. 1) into the vendor's order processing system without any human to human conversation. For example, a customer order represented by a barcode, QR code or any other scan able encoding is scanned from the customer's handheld smart device using a scanner (“D-0” in FIG. 1) installed at the vendor infrastructure (“D” in FIG. 1).

7. A method of claim 6 wherein an alternate manifestation of order placement that requires no scanning of the encoded order. Instead the encoded order is remotely electronically transferred from the customer's smart handheld device (“B” in FIG. 1).

8. A method of claim 6 wherein the hardware and software components installed at the vendor facility depicted under “D-1” and “D-2” in FIG. 1 that come together to form a decoding process for the order generated.

9. Improvement in the overall order capture, order placement and order fulfillment process by using methods of claim 1 through claim 8 thereby increasing efficiency, accuracy, reducing order repetitions and errors due to incorrect interpretations due to manual capture processes and pitfalls associated with verbal communication like accents thereby guaranteeing a pleasant overall experience resulting in time savings for the customer and increased customer satisfaction. Getting more orders in quickly and accurately would equate reduced cost and human energy spent on getting it right resulting in increased productivity for the vendor.

10. A method of claim 8 wherein an ultimate customer experience is envisioned by using integration with technologies like Google Wallet which would make the ‘One scan’ ordering a reality. This means a customer would just point their handheld smart devices at the scanner and finish their orders. The only thing they would then need to do is pick up their order. The unique interface of this concept with payment services offered by Google wallet would mean that the payment process will also be a seamless integrated experience making ordering a very pleasant experience end to end effectively yielding optimum customer satisfaction.
